(19) United States
(12) Patent Application Publication
(10) Pub. No.: US 2021/0303782 A1
(43) Pub. Date: Sep. 30, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Masayuki YAMAGUCHI, Kanagawa (JP); Tadao MICHIMURA, Kanagawa (JP); Naoyuki ENOMOTO, Kanagawa (JP)

(73) Assignee: FUJIFILM Business Innovation Corp., Tokyo (JP)

(21) Appl. No.: 16/924,161

(22) Filed: Jul. 8, 2020

(30) Foreign Application Priority Data
Mar. 24, 2020 (JP) 2020-052317

(51) Int. Cl. G06F 40/194

(52) U.S. Cl. CPC G06F 40/194

(57) ABSTRACT

An information processing apparatus includes a processor configured to receive a first process result as a result of a character recognition process performed on a first document and a second process result as a result of the character recognition process performed on a second document, calculate a cosine similarity in accordance with first position information on multiple specific characters present in the first document and detected in the first process result and second position information on the multiple specific characters present in the second document and detected in the second process result, and if the calculated cosine similarity is equal to or above a predetermined threshold, determine that the first document is identical in format to the second document.

### CROSS-REFERENCE TO RELATED APPLICATIONS

This application is based on and claims priority under 35 USC 119 from Japanese Patent Application No. 2020-052317 filed Mar. 24, 2020.

### BACKGROUND

### (i) Technical Field

The present disclosure relates to an information processing apparatus and non-transitory computer readable medium.

### (ii) Related Art

Techniques are available to determine a similarity between ledgers by comparing forms of and written contents on the ledgers as disclosed in Japanese Unexamined Patent Application Publication No. 2009-025856 and Japanese Patent No. 5110793. According to Japanese Unexamined Patent Application Publication No. 2009-025856, types of ledgers are roughly narrowed through ledger image vector matching. The ledger image vector matching is performed by making a feature vector from the whole ledger image and calculating distance to a dictionary. Sameness between similar ledgers is identified using logo marks on documents.

### SUMMARY

Aspects of non-limiting embodiments of the present disclosure relate to determining sameness of formats of documents using characters other than logo marks on the documents.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a processor configured to receive a first process result as a result of a character recognition process performed on a first document and a second process result as a result of the character recognition process performed on a second document, calculate a cosine similarity in accordance with first position information on multiple specific characters present in the first document and detected in the first process result and second position information on the specific characters present in the second document and detected in the second process result, and if the calculated cosine similarity is equal to or above a predetermined threshold, determine that the first document is identical in format to the second document.

### BRIEF DESCRIPTION OF THE DRAWINGS

Exemplary embodiment of the present disclosure will be described in detail based on the following figures, wherein:

FIG. 1 is a block diagram illustrating an information processing apparatus in accordance with an exemplary embodiment of the disclosure;

FIG. 2 is a flowchart illustrating a ledger identification process of the exemplary embodiment;

FIG. 3 illustrates an invoice as an example of a ledger;

FIG. 4 illustrates an example of a data structure as key and value extraction results extracted from the ledger in accordance with the exemplary embodiment; and

FIG. 5 illustrates the sameness determination of ledgers in accordance with the exemplary embodiment.

### DETAILED DESCRIPTION

Referring to the drawings, the exemplary embodiment of the disclosure is described below. In accordance with the exemplary embodiment, the documents processed by an information processing apparatus 1 are ledgers.

The information processing apparatus 1 of the exemplary embodiment may be implemented by widely available hardware, such as a personal computer (PC). Specifically, the information processing apparatus 1 includes a central processing unit (CPU), memory such as read-only memory (ROM), random-access memory (RAM), and/or hard disk drive (HDD), input unit, such as a mouse and keyboard, user interface, such as a display, and communication unit, such as a network interface.

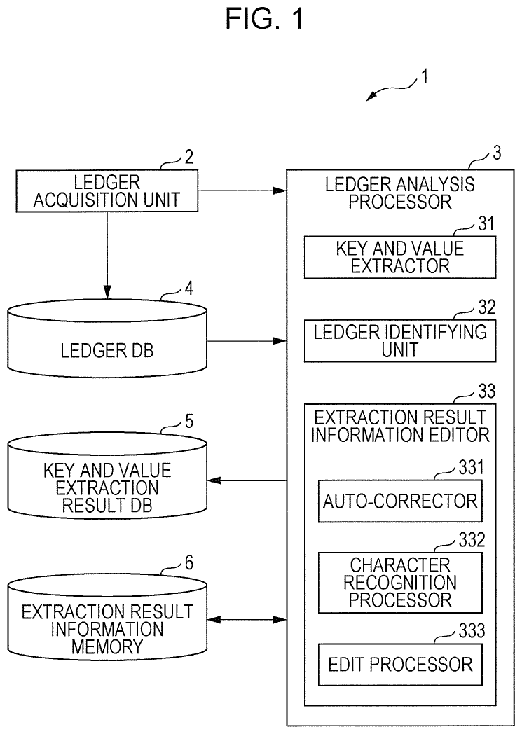

FIG. 1 is a block diagram illustrating the information processing apparatus 1 in accordance with an exemplary embodiment of the disclosure. The information processing apparatus 1 of the exemplary embodiment includes a ledger acquisition unit 2, ledger analysis processor 3, ledger database (DB) 4, key and value extraction result DB 5, and extraction result information memory 6. Elements not used in the exemplary embodiment are not illustrated in the drawings.

The ledger acquisition unit 2 acquires image data on ledgers. The acquired image data is stored on the ledger DB 4 and also transferred to the ledger analysis processor 3. The ledger analysis processor 3 identifies the format of the ledger by analyzing the image data on the acquired ledger, creates extraction result information as appropriate as information used to identify the format of the ledger, and registers the extraction result information on the extraction result information memory 6.

The “format of the ledger” may be considered to be a form applied to the ledger. For example, for types of legers, such as an invoice or delivery note, the format of the ledger is different if the form of the ledger is different. For example, if a ledger is an invoice, the ledger includes characters identifying a title indicating the invoice, date of issue of the invoice, invoice number, billing destination, and biller. The characters written on the ledger are common in terms of the type of invoice and may be detected in any two invoices if they serve as comparison targets. The writing position of characters may be different from form to form (from format to format) of ledgers in considerable cases. In accordance with the exemplary embodiment, two ledgers are compared. If the positions of the characters on the ledgers are identical to each other, the two ledgers have an identical format. If the positions of the characters on the ledgers are different from each other, the two ledgers are different in format.

In accordance with the exemplary embodiment, the “date of issue” and the “invoice number” of the invoice written on the ledger are referred to as a “key”. In the ledger, the key is typically associated with characters. For example, characters representing the date of issue in a date format may be written in a vicinity of the key “date of issue” and characters expressed in a number format may be written in a vicinity of the key “invoice number”. If the key is an item name, the date or number is an item value. In accordance with the exemplary embodiment, a character written in association with a key is referred to as a “value”. If a specific character corresponding to a key is found in the leger by analyzing image data on the ledger, a value may be present in the vicinity of the key (typically to the right of the key or below the key). The key and value may thus be extracted from the ledger. By scanning the ledger, a combination of the key and value is automatically extracted from a read image (image data) of the ledger. Only the key or only the value may be sometimes extracted. In accordance with the exemplary embodiment, one of the related art techniques is used to extract the key and/or the value. In accordance with the exemplary embodiment, unless otherwise specifically noted, the “character” refers to a single character or a character string including multiple characters.

Turning back to FIG. 1, the ledger analysis processor 3 includes a key and value extractor 31, ledger identifying unit 32, and extraction result information editor 33. As previously described, the key and value extractor 31 extracts the key and value by performing a character recognition process on the image data on the ledger. In the following discussion, the process result of a key and value extraction process is referred to a key and value extraction result. The ledger identifying unit 32 identifies the ledger by determining the sameness between the ledger with the key and value extracted therefrom and the ledger with extraction result information thereof registered on the extraction result information memory 6. Specifically, the ledger identifying unit 32 determines the format of the ledger. As will be described in detail below. the ledger identifying unit 32 creates the extraction result information as appropriate and then registers the extraction result information on the extraction result information memory 6.

In accordance with the exemplary embodiment, the format of the ledger is determined using the extraction result information registered on the extraction result information memory 6. The extraction result information editor 33 edits the extraction result information registered on the extraction result information memory 6 to increase determination accuracy. The extraction result information editor 33 includes an auto-corrector 331, character recognition processor 332, and edit processor 333. By referring to the extraction result information, the auto-corrector 331 corrects a read position of the key or value estimated to be in error. The edit processor 333 performs the character recognition process at the read position corrected by the auto-corrector 331 to acquire a correct character, specifically, the key or value. The edit processor 333 allows the user to manually correct the read position of the key or value.

The ledger DB 4 stores the image data on the ledger acquired by the ledger acquisition unit 2. The key and value extraction result DB 5 is used to manage key and value extraction results. Information on the key and value extracted by the key and value extractor 31 is registered as the key and value extraction results. The key and value extraction results extracted by the key and value extractor 31 are registered as extraction result information and used to determine ledger sameness. In accordance with the exemplary embodiment, the extraction result information memory 6 is not used to manage the key and value extraction results. The key and value extraction results of all the legers may not necessarily be registered. The type and data structure of the extraction result information are described below.

For the convenience of explanation, the ledger DB 4 and the key and value extraction result DB 5 are incorporated in the information processing apparatus 1 in accordance with the exemplary embodiment. The information processing apparatus 1 of the exemplary embodiment is a computer used to identify ledgers and does not necessarily have to include and manage the ledger DB 4 and extraction result information memory 6. The ledger DB 4 and extraction result information memory 6 may be incorporated in an external apparatus and the information processing apparatus 1 may be acquire data from the external apparatus as appropriate.

The ledger acquisition unit 2 and ledger analysis processor 3 in the information processing apparatus 1 are implemented when the computer forming the information processing apparatus 1 operates in concert with a program running on a central processing unit (CUP) mounted on the computer. The ledger DB 4, key value extraction result DB 5, and extraction result information memory 6 in the information processing apparatus 1 are implemented by the HDD or a random-access memory (RAM) mounted in the information processing apparatus 1 or an external memory connected to the information processing apparatus 1 via a network.

The program used in the exemplary embodiment may be provided by a communication medium or may be provided in a recorded form on a computer readable storage medium, such as a compact disk read-only memory (CD-ROM) or universal serial bus (USB) memory. The program supplied from the storage medium or via a communication medium is installed on the computer. Each process is thus performed when the CPU in the computer executes the program.

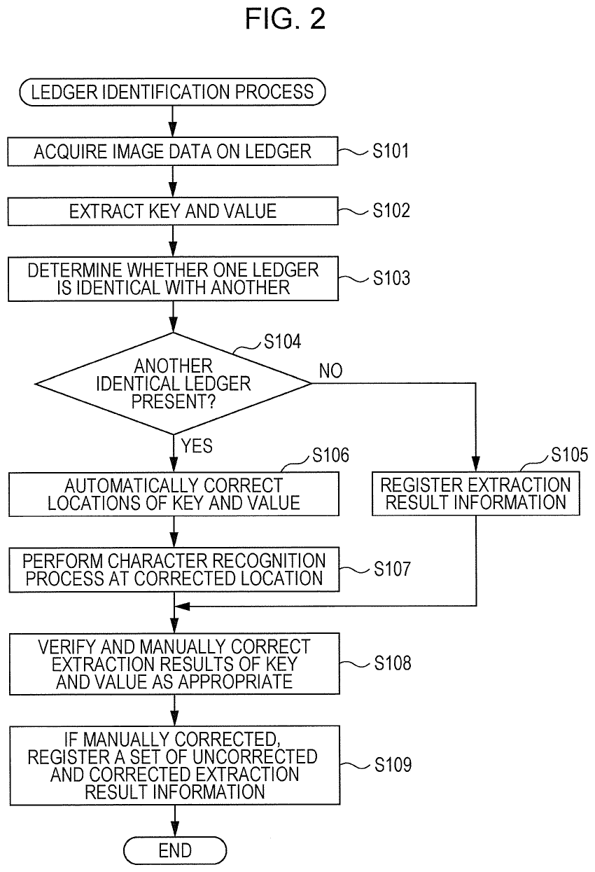

In accordance with the exemplary embodiment, the sameness of the ledgers is determined using the cosine similarity to identify each ledger. The ledger identification process of the exemplary embodiment is described with reference to a flowchart in FIG. 2. At this point of time, the extraction result information is not yet registered on the extraction result information memory 6.

The ledger acquisition unit 2 acquires image data on a single ledger (step S101). An image forming apparatus having a scan function may read a ledger. The image data on the ledger thus created by the image forming apparatus is directly or indirectly obtained. The ledger acquisition unit 2 registers the acquired image data on the ledger on the ledger DB 4 while also transferring the image data to the ledger analysis processor 3. In the following discussion, the image data on the ledger acquired in step S101 and serving as a process target in the process described below is simply referred to as a “ledger”.

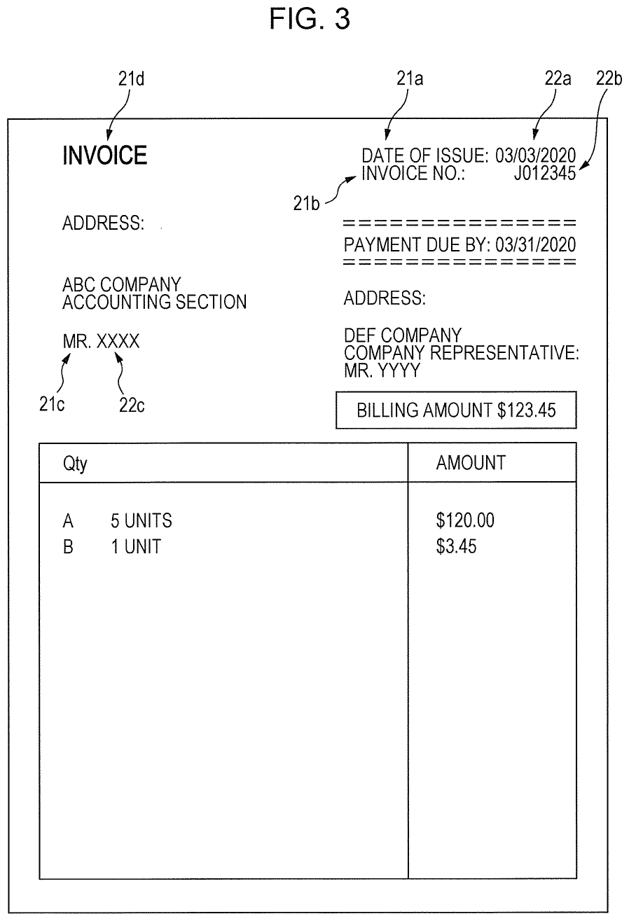

When the ledger is obtained from the ledger acquisition unit 2, the key and value extractor 31 in the ledger analysis processor 3 performs a key and value extraction operation by analyzing the ledger and by automatically extracting a key and a value corresponding to the key through a related-art technique (step S102). The key and value extraction results are registered on the key and value extraction result DB 5. More in detail, a character recognition process is performed on the ledger and position information on multiple specific characters detected from the process result (namely, the key and value) is acquired. FIG. 3 illustrates the format of the ledger when the acquired ledger is an invoice.

Referring to FIG. 3, the invoice includes, as keys, particular characters “date of issue” 21a, “invoice number” 21b, “Mr.” 21c to extract values “03/03/2020” 22a, “J012345” 22b, and “XXXX” 22c, respectively. Referring to FIG. 3, if particular characters 21a, 21b, and 21c serving as keys are not discriminated, they are collectively referred to as “key 21”. If the values 22a, 22b, and 22c corresponding to the keys 21a, 21b, and 21c are not discriminated, they are collectively referred to as “value 22”. The keys 21 include an “invoice” 21d that has no value 22 associated therewith. Conversely, a value 22 having no corresponding key 21 is present although it is not illustrated in FIG. 3.

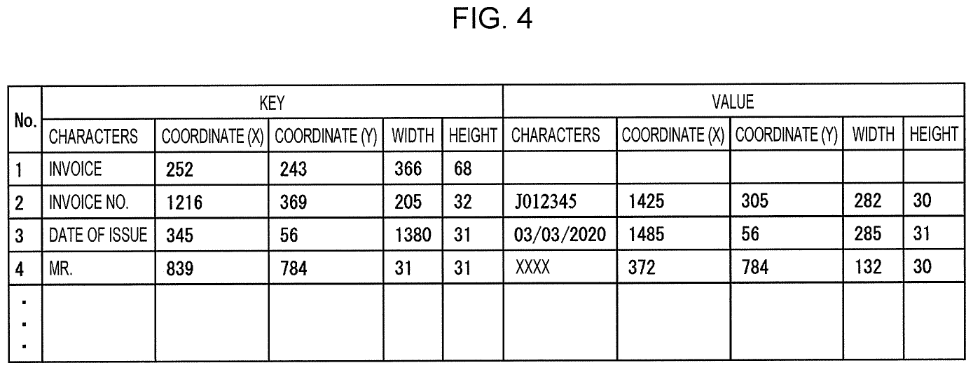

FIG. 4 illustrates an example of a data structure of the kay and value extraction results the key and value extractor 31 has extracted from the ledger. It is noted that FIG. 4 illustrates an example of the data structure and the data value is not necessarily true. Referring to FIG. 4, a serial number is assigned to each combination of key and value to manage the key and value. Characters indicating the key and value are associated with coordinates, width, and height. In the discussion herein, the key and value are not particularly discriminated from each other and unless otherwise particularly noted, the key and value are collectively referred to as a “character”.

An area where a character is present (namely, a position of the character) is identified in a rectangular region surrounding the character in the ledger. Coordinate X and coordinate Y are information indicating the position of the character. In accordance with the exemplary embodiment, the center of the ledger is central coordinates, the position of the character is represented by coordinates indicating the top left corner of the rectangular region surrounding the character (namely, a key and a value) detected through the key and value extraction process, relative to the central coordinates. The width is the width of the rectangular region (namely, the length in the X axis direction corresponding to the horizontal length of the region). The height is the height of the region (namely, the length in the Y axis direction corresponding the vertical length of the region). The position information on the character includes the size of the rectangular region and coordinate information at the top left corner of the rectangular region. Referring to FIG. 4, the key at serial No. 1 corresponds to a blank record of value and thus has no corresponding value.

The ledger identifying unit 32 refers to the key and value extraction results of the ledger acquired in step S102 and the extraction result information registered on the extraction result information memory 6 and then determines the sameness of the ledger with the ledger acquired in the past (step S103). At this time of point as previously described, no extraction result information is yet registered on the extraction result information memory 6. The ledger identifying unit 32 thus determines that one ledger in the same format as another ledger is not present (no path from S104). The ledger identifying unit 32 registers on the extraction result information memory 6 the key and value extraction results acquired in step S102 as the extraction result information on the extraction result information memory 6 (step S105). In the following discussion, the key and value extraction results acquired in step S102 is referred to as “uncorrected extraction result information”.

The edit processor 333 in the extraction result information editor 33 displays, in an editable form, position information on the character contained in the ledger. The ledger is displayed on a screen in a manner that distinctly indicates a combination of automatically extracted key and value. For example, a frame surrounding an area identified by the position information on the keys and values (namely, a rectangular region) is displayed and the keys and the values are surrounded in frames of different color frame lines. The same group is surrounded in the same color frame line. A combination of keys and values and a type of keys and values are distinctly recognized. This example is described for exemplary purposes only. For example, the rectangular region may be displayed in a different fashion, for example, may be filled.

If the ledger is an invoice, the correct invoice number (namely, value) below the key “invoice number” is to be written. In a key and value extraction operation in step S102, a character to the right of the key “invoice number” may be automatically extracted as a value. In such a case, the user moves the frame surrounding the character to the right of the key to surround the character of the correct value in accordance with a predetermined operation. The user may use another operation to specify the correct value. In response to the user correction operation to the value position, the edit processor 333 updates coordinate information on the value (coordinate X and coordinate Y) in FIG. 4. If the length of the characters is different, the user may modify the size of the frame through a predetermined operation. In response to the user correction operation to the size of the frame, the edit processor 333 modifies the size of the rectangular region of the value (at least one of the width and the height of the rectangular region) in FIG. 4. The position of the value has been described. The position of the key may also be corrected in a similar fashion.

If the user has corrected the key and value in position as appropriate (step S108), the edit processor 333 registers, as corrected extraction result information, the extraction result information that reflects the correction and uncorrected extraction result information in combination on the extraction result information memory 6 (step S109). The edit processor 333 updates the key and value extraction results registered on the key and value extraction result DB 5 with the corrected extraction result information. The key and value extraction results registered on the key and value extraction result DB 5 are updated with the latest extraction result information, though this operation is not repeatedly described in the following discussion.

If the extraction result information is not corrected by the user, the corrected extraction result information is not created. The uncorrected extraction result information registered in step S105 alone remains stored.

If the ledger in a format with the extraction result information thereof not registered in the past on the extraction result information memory 6 is read, the extraction result information is created and registered on the extraction result information memory 6.

The ledger identification process in FIG. 2 starts when another ledger is read. The process until the key and value extraction operation (step S102) is performed is identical to the process described above. The ledger identifying unit 32 refers to the key and value extraction results acquired in step S102 and the extraction result information registered on the extraction result information memory 6 and determines the sameness between the present ledger and past ledger (step S103). If one ledger identical to another ledger is present, a process described below is performed. If one ledger identical to another ledger is not present (no path from S104), the operations described above (steps S105, 108, and 109) are performed.

If another ledger serving as a process target is a second ledger acquired by the ledger acquisition unit 2, the extraction result information on the ledger in a second format is registered on the extraction result information memory 6. The process described above is repeated if the ledger is not determined to be identical in format. In this way, the extraction result information for ledgers in formats determined not to be identical is registered on the extraction result information memory 6. If the extraction result information is corrected in step S108, a combination of the corrected extraction result information and the uncorrected extraction result information is registered.

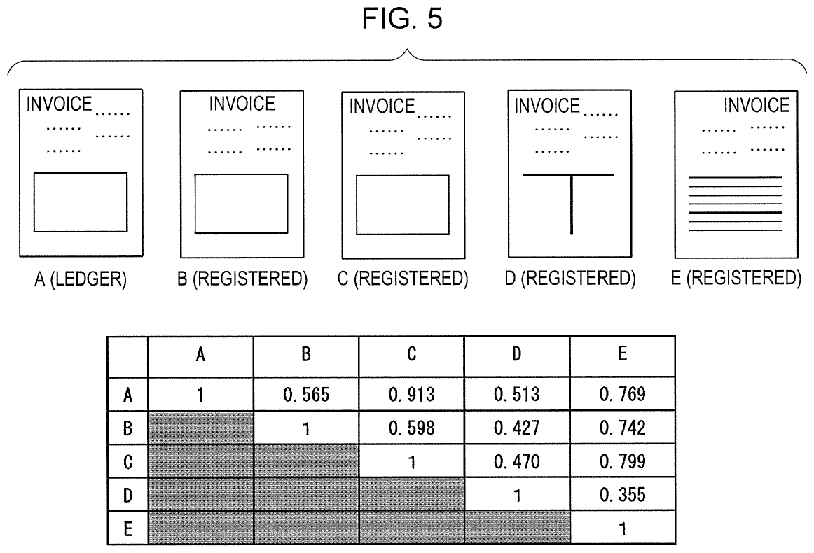

Referring to FIG. 5, the ledger identification process is repeated, registering the extraction result information on ledgers B, C, D, and E on the extraction result information memory 6 and a ledger A is newly acquired in step S101. The character recognition process is performed on the ledgers B, C, D, and E. Multiple specific characters (namely, keys and values) are detected from the process results. The position information on the keys and values on the ledgers is acquired as the key and value extraction results. The acquired extraction result information is thus registered on the extraction result information memory 6. The corrected extraction result information is also registered on the extraction result information memory 6 as appropriate. The extraction result information not corrected in step S108 is not associated with any corrected extraction result information and is thus registered alone on the extraction result information memory 6. The extraction result information registered alone on the extraction result information memory 6 is not corrected and thus corresponds to the uncorrected extraction result information for convenience of explanation.

Referring to FIG. 5, a sameness determination process of ledgers characteristic of the exemplary embodiment in step S103 is described below.

The sameness determination process of the exemplary embodiment uses the cosine similarity. In the cosine similarity, data having n elements is expanded into n-dimensional vector space to determine how data is similar. The cosine similarity falls in a range of −1 to +1. As the cosine similarity is closer to +1, the level of similarity is higher.

Referring to FIG. 5, five ledgers (invoices herein) are processed. The cosine similarity is calculated by entering keys and values. The cosine similarity may be calculated by entering all the keys and values. For convenience of explanation, six keys are set and the cosine similarity is calculated from the six keys. The key and value extraction results for the ledger A and the uncorrected extraction result information for the ledgers B through E are referred to. The cosine similarity is calculated in terms of 12 dimensions of coordinates X and coordinates Y representing the positions of the six keys.

With ledger B set to be a first document and the ledger A set to be a second document, the cosine similarity is calculated in accordance with the position information on the six keys included in the key and value extraction results of the ledger A and the key and value extraction results of the ledger B (namely, the uncorrected extraction result information). The cosine similarity is also calculated with the ledger C set to be the first document and the ledger A set to be the second document. Similarly, the cosine similarity is also calculated with each of the ledgers D and E set to be the first document.

FIG. 5 illustrates calculation results in table. If ledgers to be compared are in the same format, the similarity is 1 or extremely closer to 1. In the numerical examples of the calculation results in FIG. 5, the cosine similarity between the ledger A and the ledger C is the highest value of 0.913. In accordance with the exemplary embodiment, if the cosine similarity is equal to or above a predetermined threshold (for example, 0.8), the ledgers are determined to be identical in format. In other words, if the cosine similarity is below the predetermined threshold, the ledgers are determined to be different in format. In the numerical examples in FIG. 5, the ledger C and ledger A are determined to be identical in format (step S103). In the following discussion, a ledger as a process target acquired in step S101 is the “ledger A” and a ledger having the extraction result information registered on the extraction result information memory 6 and determined to be identical to the ledger A is the “ledger C”.

If the ledger C identical in format to the ledger A is present (yes path from step S104) and the corrected extraction result information on the ledger C is not registered, an auto-correction operation is not performed. If the corrected extraction result information on the ledger C is registered on the extraction result information memory 6, the auto-corrector 331 in the extraction result information editor 33 acquires the corrected extraction result information on the ledger C as the first document and corrects the key and value extraction results of the ledger A as a third document in accordance with the corrected extraction result information (step S106).

If the position of a character automatically extracted in the key and value extraction operation on the ledger C (step S102) is not correct, the position of the character is manually corrected by the user in step S108. Specifically, the character automatically extracted in the key and value extraction operation on the ledger A (step S102) is incorrect in position in the ledger C. The character is thus corrected in position. A character identical to the corrected character serves as a target that is to be manually corrected by the user in step S108.

In accordance with the exemplary embodiment, the uncorrected extraction result information based on the key and value extraction operation and the corrected extraction result information based on the user correction are stored in combination. Instead of allowing the user to correct in step S108, the key and value extraction results of the ledger A are automatically corrected in accordance with the corrected extraction result information in step S106. In this way, time for the user to correct the position of the character is saved.

After the automatic correction, the auto-corrector 331 calculates the cosine similarity in accordance with the position information on the uncorrected character in the ledger A and the position information on the corrected character. If the calculated cosine similarity is equal to or above the predetermined threshold, the auto-corrector 331 cancels the automatic correction of the position of the character in the ledger A. Since the position prior to the correction remains the same as the position subsequent to the correction, the correction is not only unnecessary but also leading to the possibility of an erroneous correction to the position of the character.

If the auto-corrector 331 effectively corrects the position of the character in the ledger A in accordance with the corrected extraction result information on the ledger C, the character recognition processor 332 correctly extracts the key and value by performing the character recognition process at the position of the key and value identified by the corrected extraction result information on the ledger A, namely at the correct position where the key and value are present (step S107).

It is estimated that the correct key and value extraction results are obtained for the ledger A through the process described above. Even if the position of the value is correct, a character may not be correctly extracted possibly because of a smaller rectangular region. For example, for the value corresponding to the key “address”, all characters expressing the address may possibly be difficult to extract within a rectangular region set in the extraction result information. In accordance with the exemplary embodiment, the edit processor 333 displays in an editable form the position information on the characters contained in the ledger A and enables the user to manually correct (step S108). If the position information is edited by the user, the corrected extraction result information is updated with edit results. The edit processor 333 registers the corrected extraction result information and the key and value extraction results of the ledger A in an associated form on the extraction result information memory 6 (step S109).

The extraction result information on a ledger in a format acquired for the first time may be registered alone the extraction result information memory 6. In the case of the ledger A, namely, in the case of the extraction result information in the format that is not acquired for the first time, the uncorrected extraction result information and the corrected extraction result information are stored in combination.

In such a case, the extraction result information in the same format is registered on the extraction result information memory 6. If the format of a ledger (for example, the ledger F) serving as a target of the ledger identification process is identical to the format of ledgers A and C, each of the ledgers A and C having the calculated cosine similarity equal to or above the predetermined threshold is determined to be in the same format as the format of the ledger F in step S103. In such a case, operations in step S106 and subsequent steps are performed using the extraction result information on one of the ledgers. For example, the extraction result information on the ledger having a maximum cosine similarity may be used.

In accordance with the exemplary embodiment, as described above, the key and value extraction results are referred to, the sameness of the ledgers is determined using the cosine similarity, and the key and value extraction results are corrected as appropriate. The identification accuracy of the sameness is thus improved.

Even if all the keys and values are correctly extracted in the key and value extraction operation (step S102), there is a possibility that a key and value may be further erroneously recognized, leading to extracting unwanted characters. Before calculating the cosine similarity to determine the sameness, the same character contained in the key and value extraction results of a ledger (the ledger A) provided by the key and value extractor 31 and contained in the uncorrected extraction result information on ledgers (ledgers B through E) to be compared with the ledger A are extracted. The cosine similarity is calculated from the position information on each of the extracted characters. If the calculated cosine similarity is below the predetermined threshold, the ledger identifying unit 32 does not use the position information on the character to calculate the cosine similarity that is used to determine the sameness. Specifically, the cosine similarity is calculated by excluding the position information on a character having the calculated cosine similarity below the predetermined threshold and the sameness of the ledgers serving as comparison targets is determined in accordance with the calculation results (step S103).

In such a case, the ledger identifying unit 32 displays in an editable form a position of a character extracted from a ledger as a comparison target, namely, a character with the calculation results of the cosine similarity that are calculated from the position information on the same character and are below the predetermined threshold. In this way, the user may correct the position of the character that is erroneously recognized and extracted as the key or value and may exclude the character from characters as the key or value.

In accordance with the exemplary embodiment, the sameness of the legers is determined using characters other than logo marks on the ledger and the ledgers are identified.

In the exemplary embodiment above, the term “processor” refers to hardware in a broad sense. Examples of the processor includes general processors (e.g., CPU: Central Processing Unit), dedicated processors (e.g., GPU: Graphics Processing Unit, ASIC: Application Specific Integrated Circuit, FPGA: Field Programmable Gate Array, and programmable logic device).

In the exemplary embodiment above, the term processor is broad enough to encompass one processor or plural processors in collaboration which are located physically apart from each other but may work cooperatively. The order of operations of the processor is not limited to one described in the exemplary embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising
a processor configured to
receive a first process result as a result of a character recognition process performed on a first document and a second process result as a result of the character recognition process performed on a second document,
calculate a cosine similarity in accordance with first position information on a plurality of specific characters present in the first document and detected in the first process result and second position information on the plurality of specific characters present in the second document and detected in the second process result, and
if the calculated cosine similarity is equal to or above a predetermined threshold, determine that the first document is identical in format to the second document.

2. The information processing apparatus according to claim 1, wherein the specific characters are detectable in each of the first document and the second document.

3. The information processing apparatus according to claim 1, wherein if a center of the first document is set as central coordinates of the first document and a center of the second document are set as central coordinates of the second document, the first position information is represented by coordinates of a position of an upper left corner of a rectangular region surrounding the specific characters detected in the first process result relative to the central coordinates of the first document, and the second position information is represented by coordinates of an upper left corner of a rectangular region surrounding the specified characters detected in the second process result relative to the central coordinates of the second document.

4. The information processing apparatus according to claim 1, wherein the processor is configured to
calculate the cosine similarity in accordance with position information on identical characters contained in the first document and the second document and
if the calculated cosine similarity is below a specific threshold, not use the position information on the identical character in calculating the cosine similarity used to determine format sameness.

5. The information processing apparatus according to claim 4, wherein the processor is configured to display in an editable form a position of a character contained in the first document where a result of calculating the cosine similarity from the position information on the identical characters is below the specific threshold.

6. The information processing apparatus according to claim 1, wherein the processor is configured to display in an editable form a position of the specific characters contained in the first document.

7. The information processing apparatus according to claim 6, wherein the processor is configured to
if a position of one of the specific characters contained in the first document is corrected through editing, cause to be stored the first position information indicating a position of the character prior to the correction in association with the first information indicating a position of the character subsequent to the correction,
receive a third process result that is a result of the character recognition process performed on a third document different from the first document, and
if a character for which the first position information prior to the correction on the first document is determined to be identical to third position information on a plurality of specific characters present in the third document and detected in the third process result is present, correct the third position information on the determined character in the third document by using the first position information subsequent to the correction corresponding to the first information prior to the correction in the first document.

8. The information processing apparatus according to claim 7, wherein the processor is configured to, if a cosine similarity calculated from the third position information in the acquired third document and the third position information prior to the correction is equal to or above a specific threshold, cancel the correction to the third position information on the acquired third document.

9. An information processing apparatus comprising processor means for
receiving a first process result as a result of a character recognition process performed on a first document and a second process result as a result of the character recognition process performed on a second document,
calculating a cosine similarity in accordance with first position information on a plurality of specific characters present in the first document and detected in the first process result and second position information on the plurality of specific characters present in the second document and detected in the second process result, and
with the calculated cosine similarity being equal to or above a predetermined threshold, determining that the first document is identical in format to the second document.

10. A non-transitory computer readable medium storing a program causing a computer to execute a process for processing information, the process comprising:
receiving a first process result as a result of a character recognition process performed on a first document and a second process result as a result of the character recognition process performed on a second document,
calculating a cosine similarity in accordance with first position information on a plurality of specific characters present in the first document and detected in the first process result and second position information on the plurality of specific characters present in the second document and detected in the second process result, and
with the calculated cosine similarity being equal to or above a predetermined threshold, determining that the first document is identical in format to the second document.
